(19) United States
(12) Patent Application Publication
(10) Pub. No.: US 2006/0233628 A1
(43) Pub. Date: Oct. 19, 2006

(54) Connect link and drive tool

(76) Inventor: Lanny R. Lee, Toms River, NJ (US)

Correspondence Address: Lanny R. Lee;Ste 324, 1358 Hooper Ave., Toms River, NJ, 08753-2882, US

(21) Appl. No.: 11/104,796

(22) Filed: Apr. 13, 2005

(51) Int. Cl. F16B 15/08

(52) U.S. Cl. 411/473

(57) ABSTRACT

The invention, an improved connection, provides mechanical link between two or more members. This link is preferably made from round or rectangular wire having the ends formed at right angles and parallel and are the engaging spikes. The tool driver has an angle nose piece with the angle approximately equal to the angle of the walls adjacent to the joint. This ingenious invention is further shown by the driver axis is canted so as to provide the plain of the staple to be canted to allow the driver mechanism to remain outside the area of the joining members. These spikes are only subject to deforming as the body portion of this connect link is subjected to tension. This fastener will join members with concave, convex and flat surfaces external surfaces at acute or obtuse dihedral surfaces as this fastener is a mechanical link. This invention when used to secure the stud to the plate once again makes the stud a frame member suitable for tension loads.

### BACKGROUND

This invention relates to fasteners and tools that are being used by manufacturing, industry and building construction. Specifically, this type of devices, that usually are compressed gas or motor driven, as a means of driving the fastener both staples and nails. When nails and staples are used to fasten two or more members together these conventionally they penetrate the first member and on to the members successively. The clamping is maintained by the friction of the portion of the fastener that extends into the successive members and its material. Often this friction is increased by chemical coatings with annular ribs to augment the retention.

Usually, forces to separate the members are acting at forty five degrees or less through the fastener. These separating forces to these members are likely to be great because they normally are acting on a long moment arm as a level. It is interesting to note that driven fasters are rarely used under pure shear load. These applications are best suited to combination friction with screw fasteners in construction where the use has become common. When these fasteners are used in soft coniferous wood there is only a slight structural improvement over friction fasteners, especially when the end grain is penetrated. The large diameter of the body of the fastener is needed to keep it from bending while being driven. This large body size further degrades the joint when the wood is splintered and split in the “toe nail” joining fashion.

The plank and board size of wood used for framing was decreased years ago; for example a 2×4 is still referred to as that but the actual size is much smaller. Thus, splitting and splintering is such a problem that the toe nailed connection is no longer relied on structurally. In other words the nails in the stud framing are only relied on to hold it in place until the sheeting or drywall is nailed in place. The wall stud is only a laterally constrained compression column.

### SUMMARY

The invention, an improved connection, provides mechanical link between two or more members. This link is preferably made from round or rectangular wire having the ends formed at right angles and parallel and are the engaging spikes. This shape, similar to the letter U, is on a plain with another plain normal to this plane and through the main body. The tool driver has an angle nose piece with the angle approximately equal to the angle of the walls adjacent to the joint. The axis of the stroke of the driver bisects this angle. In example: when the walls are at 90 degrees to each other the stroke will be at 45 degrees. This assures the plain of the main body of the staple is at 45 degrees to each wall; therefore, the incident angle of entry of each leg will be approximately equal. The plain of the connect link is so inserted be normal to the plain of the walls and sufficiently away from the end to avoid splitting. This ingenious invention is further shown by the driver axis is canted so as to provide the plain of the staple to be canted to allow the driver mechanism to remain outside the area of the joining members. This is particularly useful to provide swinging room when a hammer is used to drive the staple manually.

The ends of the spikes of the fastener normally don't protrude past the far surface of the penetrated member therefore they must only be stiff enough to penetrate only about half the distance needed of a conventional fastener. These spikes are only subject to deforming as the body portion of this connect link is subjected to tension.

The link is preferably made from a high tensile strength alloy that is heat treated to make it stiff to resist deforming. This provides for a sufficiently rigid fastener and yet a body area or thickness small enough to avoid splitting the grain when being used in wood or chipping when used to fasten in other solids. This fastener will join members with concave, convex and flat surfaces external surfaces at acute or obtuse dihedral surfaces as this fastener is a mechanical link. This invention when used to secure the stud to the plate once again makes the stud a frame member that is good for tension loads.

Accordingly several objects and advantages of the invention provide a link driver and link with broader use applications.

### DRAWINGS

FIG. 1 is a prospective view of a connect link.

FIG. 2 is a front isometric view of a connect link.

FIG. 3 is a side isometric view of the connect link.

FIG. 4 is a prospective view of a connect link.

FIG. 5 is a prospective view of another connect link.

FIG. 6 is a prospective view of a drive tool.

FIG. 7 is a side view of a drive tool.

FIG. 8 is a front view of a drive tool.

FIG. 9 is an enlarged partial view of a drive tool.

FIG. 10 is a side view of a canted axis drive tool.

FIG. 11 is a front view of a canted axis drive tool.

FIG. 12 is an exploded isometric view of a connection.

FIG. 13 is a front view of a connection showing drive tools.

FIG. 14 is an isometric view of a connection.

FIG. 15 is a partial front section view of a connection.

FIG. 16 is an exploded isometric view of a manual driver tool.

FIG. 17 is an isometric view of a connection showing cut

FIG. 18 is an isometric view of a connect link.

FIG. 19 is an isometric view of a sample application.

FIG. 20 is an isometric view of a showing drive tool.

FIG. 21 is an isometric view of a showing drive tool.

FIG. 22 is an isometric view of a showing drive tool.

FIG. 23 is an isometric view of a showing drive tool.

### DESCRIPTION

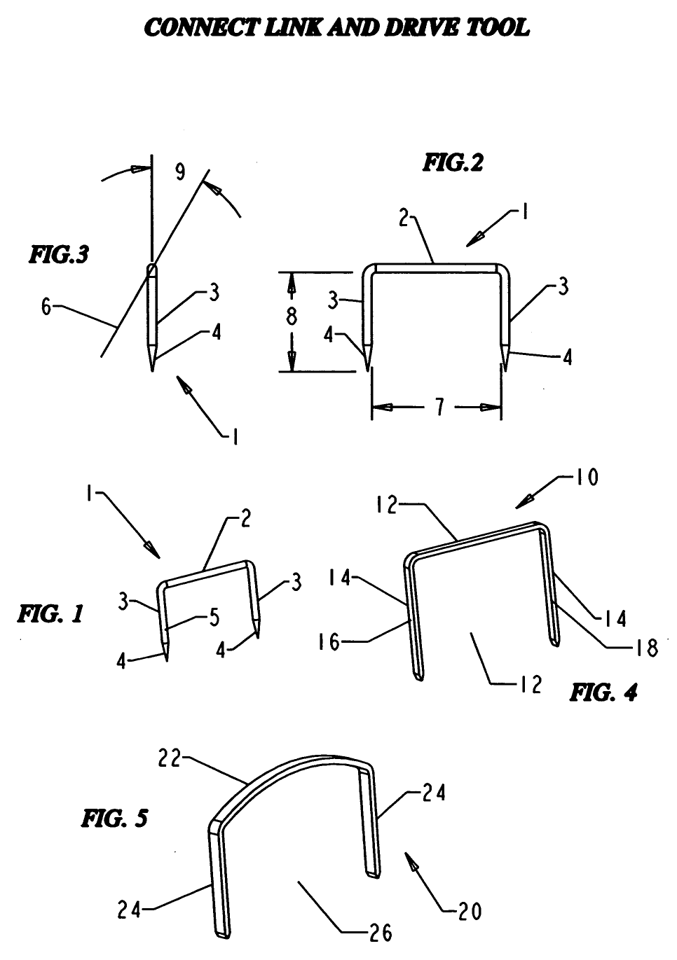

FIG. 1 is a prospective view of a link 1 having a crossbar 2 with upright spike 3 ending in cone point 4. The link 1 shown formed from a protrusion with curved surface 5. Shown in FIG. 2, a front view again shows crossbar 2 and upturned legs 3 each ending in cone point 4 providing for connection span 7 and engagement length 8. The view shown in FIG. 3 is an end view of link 1 and a canted plane 6 defined as angle 9 through link 1. Another configured connect link 10 is shown FIG. 4 having crossbar 12 and formed from a protrusion with planar sides 16 and comers 18 also with upright legs 14 defining connection span 12. FIG. 5 is a connect link 20 with a conformed crossbar 22 and upright legs 24.

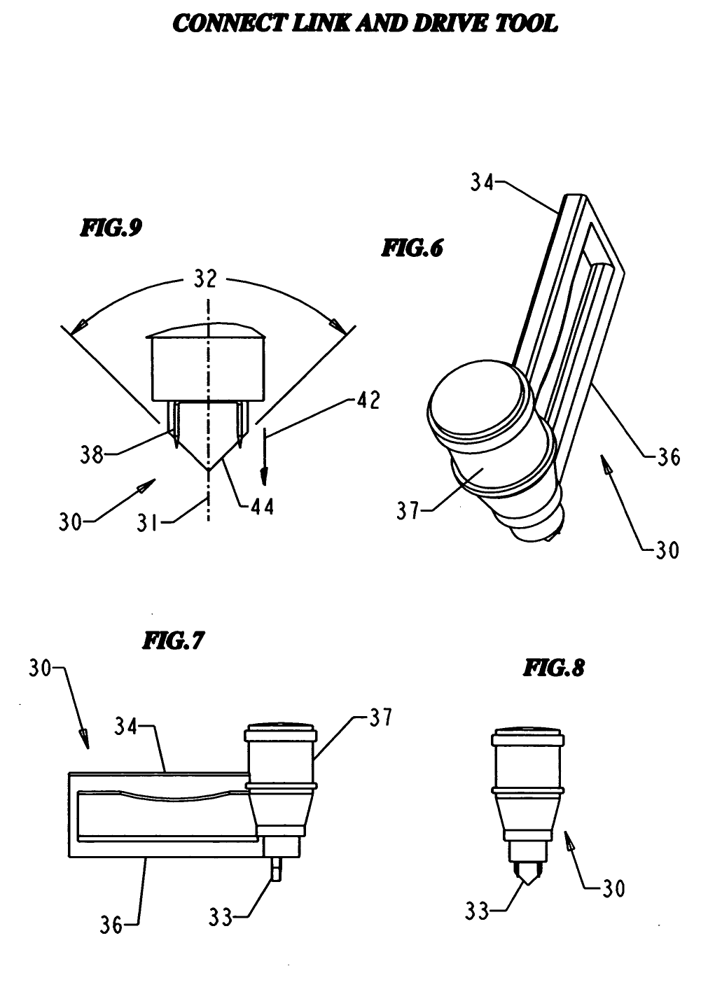

A drive tool 30 is shown in isometric view in FIG. 6 with a housing 37 connected to a handle 34 approximately parallel to a connect link magazine 36. FIG. 7 is a side view of a drive tool 30 and FIG. 8 is an end view showing housing 37 and header 33 of a drive tool 30. FIG. 9 is an enlarged partial view of drive tool 30 to show connect link 38 driven out in direction 42 and angle base 44 guides driver 30. Variable angle 32 varies to suit dihedral angle of side planes of members. Variable angle 32 varies from acute to 180 degrees.

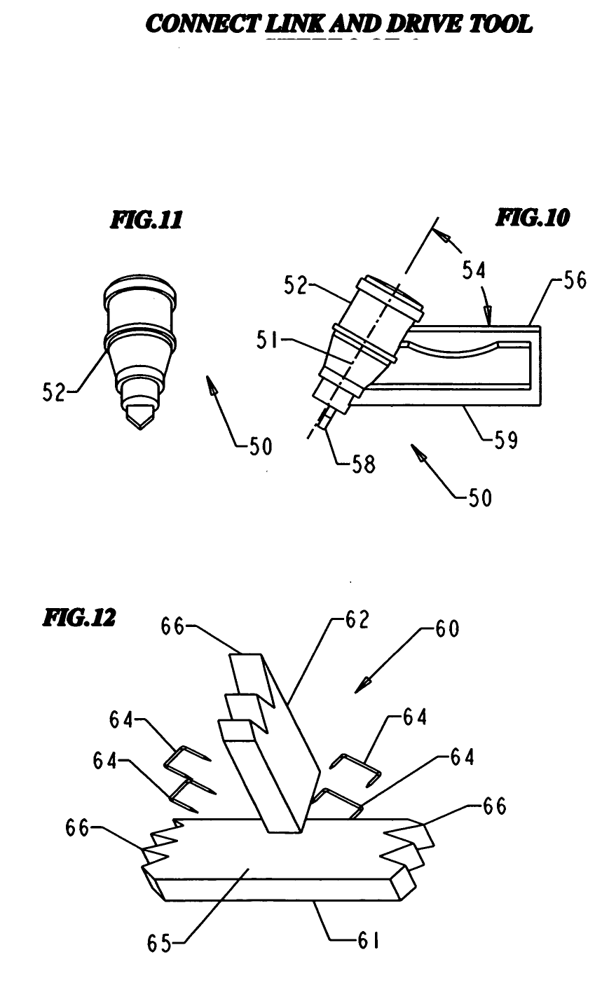

FIG. 10 is a canted drive tool 50 with canted power housing 52 connected handle 56 and connect link magazine 59 at connect angle 54 providing dihedral angle header 58 forward of housing 52. FIG. 11 is front view showing dihedral angle header 58. FIG. 12 is an exploded isometric view showing a connected assembly 60 comprising of a base member 65 and a mating member 62 with connect link 64. Schematic breaks are represented by 66.

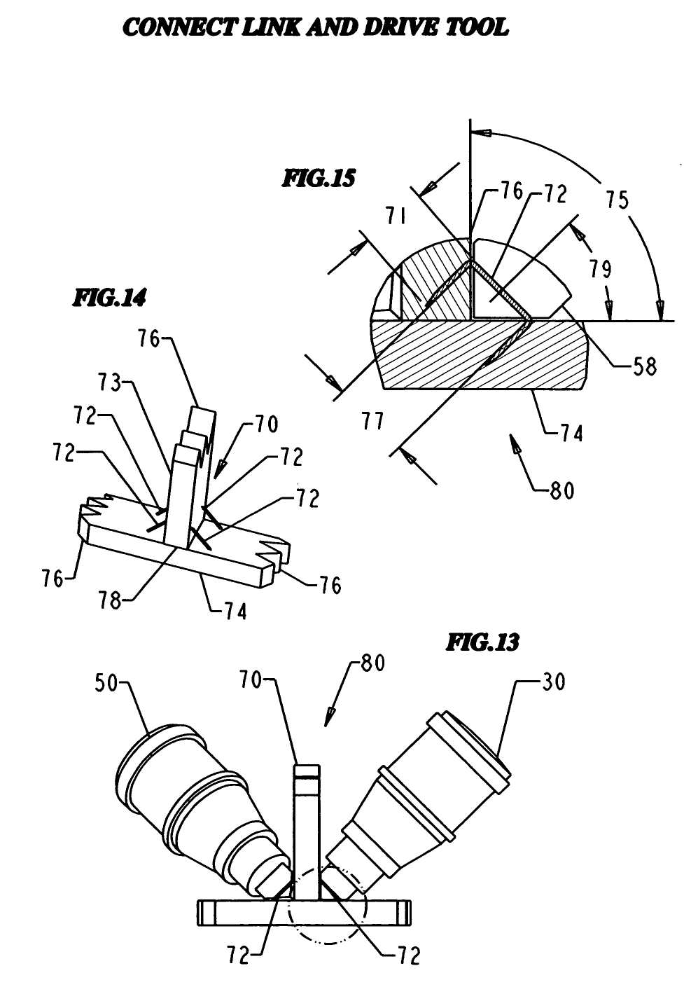

FIG. 13 shows a side view application process 80 of drive tool 30 and canted axis drive tool 50 with assembly 70. A connected assembly 70 is seen in isometric view FIG. 14 with base 74 connected to mating member 73 with connect link 72. Schematic break 76 is shown at member ends. An enlarged partial view is seen in FIG. 15 with a section through connect link 72. Dihedral angle 75 is shown with a bisect angle 79 being the optimal angle of drive tool axis 31 to drive connect link 72 to depth 71. Optimal connection span 77 and angle header 58 is seen behind the section.

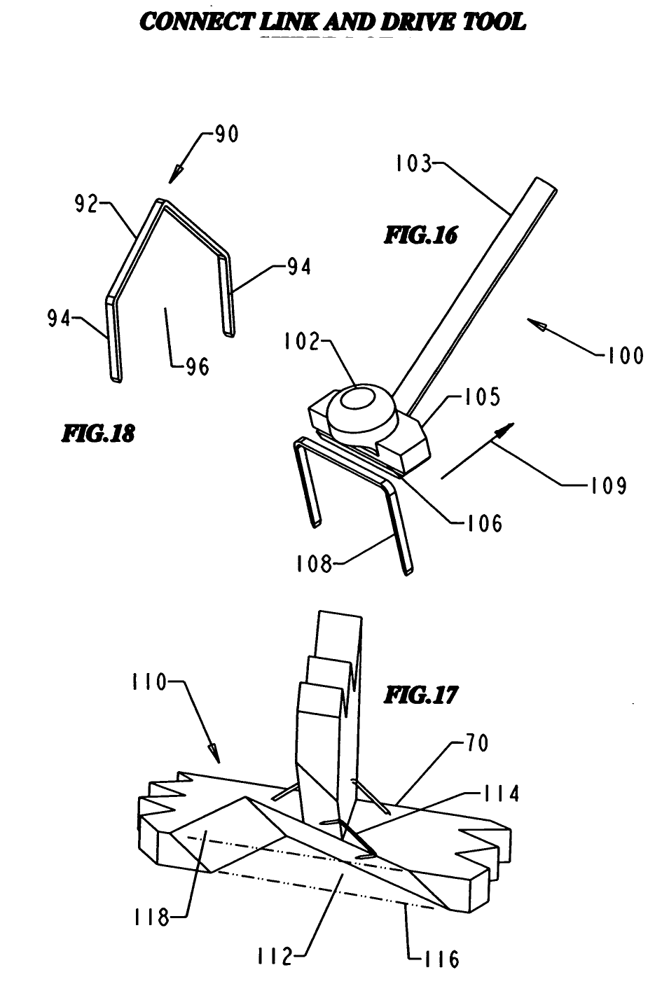

FIG. 16 is a view showing a holder 100 having a handle 103 to manually align holder 100 to the desired position to drive a connect link 108 by striking pad 102 with a hammer. Holder 100 is withdrawn from link 108 by moving in the direction shown by arrow 109 from groove 106. FIG. 17 once again shows connected assembly 70 with a partial cut 118 through a canted connect link 114. Removed material 112 is represented by phantom lines 116. Shown in FIG. 18 is another connect link 90 where the main body is formed in angle 92 and both ends are formed to parallel legs 94 whereby connection span 96 is defined.

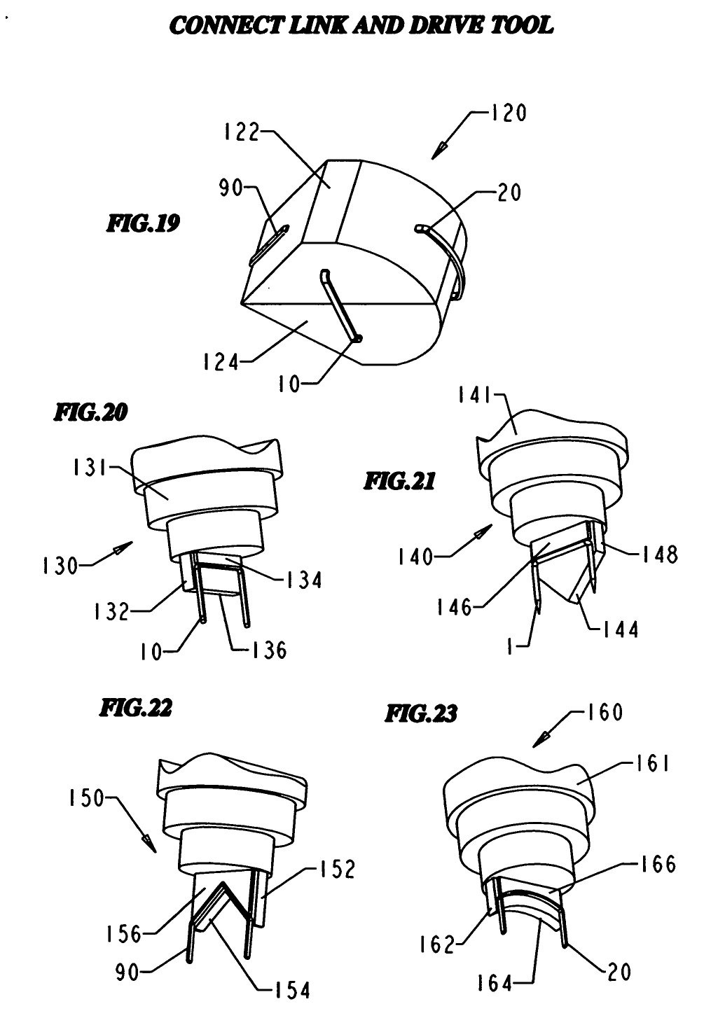

FIG. 19 is a demonstration assembly 120 where connect link 10, connect link 20 connect link 90 are used to connect block 122 to block 124. FIG. 20 is a partial view drive tool 130 whereby drive tool tip 131 is shown having header 132 with a flat rest plane 136 and an extendible blade 134. Connect link 10 urged my means to traverse downward. FIG. 21 is also a partial view drive tool 140 whereby drive tool tip 141 is shown having a header 148 with angle dihedral rest plane 144.

Extendible blade 146 urges connect link 1 by means to traverse downward. FIG. 22 is also a partial view drive tool 150 whereby drive tool tip 151 is shown having a header 152 with angle dihedral rest planes 154. Extendible blade 156 urges connect link 90 by means to traverse downward. FIG. 23 is also a partial view drive tool 160 whereby drive tool tip 161 is shown having a header 162 with curve rest planes 164. Extendible blade 166 urges connect link 20 by means to traverse downward.

I claim:

1. A means of driving a link a and a link comprising of a body protrusion having formed parallel upturned legs and said legs each penetrating one or more members whereby a connection is made between members.

2. A means of driving a link of and a connect link of according to claim 1 comprising of a body protrusion having formed parallel upturned legs and said legs each penetrating one or more members whereby a connection is made between members whereby said link is formed from a approximately cylindrical protrusion.

3. A means of driving a connect link of and a connect link according to claim 1 comprising of a body protrusion having formed parallel upturned legs and said legs each penetrating one or more members whereby a connection is made between members whereby said link is formed from a approximately polygonal protrusion.

4. A means of driving a connect link of and a connect link according to claim 1 comprising of a body protrusion having formed parallel upturned legs and said legs each penetrating one or more members whereby a connection is made between members whereby said link is formed from a metal.

5. A means of driving a connect link of and a connect link according to claim 1 comprising of a body protrusion having formed parallel upturned legs and said legs each penetrating one or more members whereby a connection is made between members whereby said connect link is formed from a plastic.

6. A means of driving a connect link of and a connect link according to claim 1 comprising of a body protrusion having formed parallel upturned legs and said legs each penetrating one or more members whereby a connection is made between members whereby drive means is a air powered drive tool.

7. A means of driving a connect link of and a connect link according to claim 1 comprising of a body protrusion having formed parallel upturned legs and said legs each penetrating one or more members whereby a connection is made between members whereby drive means is a electric powered drive tool.

8. A means of driving a connect link of and a connect link according to claim 1 comprising of a body protrusion having formed parallel upturned legs and said legs each penetrating one or more members whereby a connection is made between members whereby driver means is a manual drive tool.

9. A means of driving a connect link of and a connect link according to claim 1 comprising of a substantially straight body protrusion having formed parallel upturned legs and said legs each penetrating one or more members whereby a connection is made between members.

10. A means of driving a connect link of and a connect link according to claim 9 whereby drive means header base plane and extendable blade plane are approximately flat.

11. A means of driving a connect link of and a connect link according to claim 9 whereby drive means header base plane is angled and extendable blade plane are approximately flat.

12. A means of driving a connect link of and a connect link according to claim 1 comprising of a substantially conformal curve body protrusion having formed parallel upturned legs and said legs each penetrating one or more members whereby a connection is made between members.

13. A means of driving a connect link of and a connect link according to claim 12 whereby drive means header base plane and extendable blade plane are approximately conformal curved.

14. A means of driving a connect link of and a connect link according to claim 1 comprising of an angled body protrusion having formed parallel upturned legs and said legs each penetrating one or more members whereby a connection is made between members.

15. A means of driving a connect link of and a connect link according to claim 14 whereby drive means header base plane and extendable blade plane are have angle planes.

16. A means of driving a link a and a link comprising of a body protrusion having formed parallel upturned legs and said legs each penetrating one or more members whereby a connection is made between members whereby header bases and extendable blades are interchangeable.

17. A means of driving a connect link a and a connect link comprising of a body protrusion having formed parallel upturned legs and said legs each penetrating one or more members whereby a connection is made between members whereby drive means axis is angled to handle.

18. A means of driving a connect link a and a connect link comprising of a body protrusion having formed parallel upturned legs and said legs each penetrating one or more members whereby a connection is made between members whereby drive means header planes are canted to allow connect link plane to is be driven canted.
